(19) United States
(12) Patent Application Publication
(10) Pub. No.: US 2024/0107994 A1
(43) Pub. Date: Apr. 4, 2024

(54) SYSTEMS AND METHODS OF DISSEMINATING ANIMAL HUNTING SCENTS

(71) Applicant: Richard MacGlashing, Kingston, NH (US)

(72) Inventor: Richard MacGlashing, Kingston, NH (US)

(21) Appl. No.: 18/475,349

(22) Filed: Sep. 27, 2023

Related U.S. Application Data
(60) Provisional application No. 63/411,730, filed on Sep. 30, 2022.

(51) Int. Cl. A01M 31/00

(52) U.S. Cl. CPC A01M 31/008

(57) ABSTRACT

A bubble forming composition and bubble distribution system which contains scents within the bubble solution effective for hunting and trapping purposes. Such scents include masking scents and/or luring scents. Bubbles are able to float along air currents to better disperse scent compared to sprays and spritzers. Moreover, bubbles provide a very detailed visual presentation of both wind as well as thermals and other air currents. This allows one to visualize and understand not only wind direction but also more subtle air currents in a given area.

### TECHNICAL FIELD

The present invention relates to disseminating animal scents for use with hunting and other outdoor activities where luring animals via scent and/or avoiding animals by masking human scent are used.

### BACKGROUND OF THE INVENTION

Current methods of spreading scents involve spraying scents on or around the areas where a hunter or animal observer would position themselves. One of the problems is trying to understand where to spread the scent, as well as being able to spread the scent in an efficient manner. In particular it is often difficult to identify wind direction and speed, which is very important for proper scent masking. Another problem is being able to spread the animal scent over greater distances than traditional spray bottles. Sprays or other traditional dissemination systems rely on small particle size and volatility to spread scent. These are inherently limited because spray particles are not effectively carried by the wind and eventually fall to the ground, while highly volatile compounds are able to rapidly get in the air but they evaporate before travelling to a meaningful distance away from the source.

The systems and methods described herein seek to solve these above problems and provide advantages that will become apparent to those skilled in this art.

### SUMMARY OF THE INVENTION

The present application relates to compositions, systems, and methods for disseminating an animal scent solution. In particular, the present application involves a sent solution having components allowing it to be blown into a bubble or bubbles using tools such as a bubble wand, bubble gun, or automated bubble machine, as well as systems and methods of doing so.

In one aspect, the animal scent solution to be blown into bubbles comprises 1) water, 2) detergent, 3) pH balancing component, 4) at least one of glycerin, sugar and polymer, and 5) an animal luring or covering scent.

In another aspect, a method of disseminating an animal scent solution is provided. The method may comprise the steps of: A) placing a portion of an animal scent solution into a bubble generating device, wherein the animal scent solution is comprised of: 1) water, 2) detergent, 3) pH balancing component, 4) at least one of glycerin, sugar and polymer, and 5) an animal luring or covering scent; B) determining the direction of the wind relative to a user; and C) disseminating the animal scent solution downwind from the user in the form of bubbles as generated by the bubble generating device.

The above noted animal scent can be an animal-derived scent which is obtained from an animal or an artificial source that operates to present a scent emitted by an animal that can lure animals and/or cover the scent of a hunter. Animal based scents may include: deer urine, including doe and/or buck urine, as well as deer tarsal gland extract alone or combined with deer urine, doe estrus (also called “hot doe” urine), as well as other animal urine or urine scent such as fox and raccoon, or other animal-derived scent components or extracts including but not limited to animal pheromones, musk, extracts, bodily fluids, and the like. The scent component may also be a plant-derived luring or covering scent. Such plant-derived scents may include, for example, pine scent, corn, apple, or acorn scent and the like. In embodiments other embodiments, such as those seeking to lure an animal such as a bear, the above method the animal scent can include one of: jelly donut, glaze donut, or sugar cookie scent.

The above method wherein the animal scent solution may comprise a plant-derived vegetable glycerin, which provides a thick and durable bubble to allow for longer travel and scent distribution. The animal scent can also be comprised of at least two of glycerin, sugar and polymer, and wherein the sugar can be glucose, fructose, sucrose, or lactose.

The above method wherein the bubble generating device has an aperture region whereby the animal scent solution can span across and is open to airflow. The bubble generating device can further include a fan configured to move airflow across the aperture. Exemplary bubble generating devices include, but are not limited to, bubble wands, automated bubble machines, and hand held or remote bubble guns.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 provides a view of bubble flow following air currents.

FIG. 2 provides a view of an embodiment of a bubble generating device, shown in this view as a bubble gun.

FIG. 3 provides a view of an embodiment of the present disclosure using the scented bubbles to identify wind and air currents and also to provide a masking and/or luring scent.

FIG. 4 provides a view of an embodiment of the present disclosure using the scented bubbles to identify wind and air currents and also to provide a masking and/or luring scent.

FIG. 5 provides a flow chart of one embodiment of the present disclosure.

FIG. 6 provides a flow chart of another embodiment of the present disclosure.

FIG. 7 provides a flow chart of yet another embodiment of the present disclosure.

### DETAILED DESCRIPTION

The present disclosure utilizes bubbles as a highly efficient way to spread and disseminate a scented solution. Bubbles are extremely light weight and thus travel widely in the direction of the wind, and travel drastically better than a traditional spray.

Some of the advantages of using an animal scent solution that is configured to form bubbles that can be carried by the air more than 5 feet, more than 10 feet, more than 15 feet, and even more than 20 feet is the ability to quickly and effectively spread the desired scent (animal based or derived, artificial animal scent, natural or artificial plant scent, natural or artificial food scent, and the like) over a larger area. The inventor of these methods uses the term quickly in comparison to traditional spray or spritz bottles that are currently being used to disseminate an animal scent solution. Bubbles travel further and over a greater area faster than trying to spray the same area. In particular, if an automated bubble blowing device, such as a bubble blowing gun is used. These types of auto-blowing devices can produce and spread the animal scent solution in bubble form over a large distance as guided by the wind as well as local thermals and other air movements. Alternatively, the user can use a traditional bubble blowing wand, and still achieve some of the same results.

Importantly, it was unexpectedly found that bubbles and common human scent particles travel an approximately similar distance and along the same path. This makes the presently disclosed bubble system particularly well suited for a covering scent and solves the problem in the prior art that traditional covering scents do not cover a wide enough area, allowing animals to smell the hunter.

The direction of the wind is going to dictate where the user spreads or directs the animal scent bubbles. In most hunting or animal observation cases, the user ideally tries to position themselves downwind from an animal, which makes it more difficult for the animal to smell the user. When it is unclear which direction the animal may be coming from, the user disseminates animal scent that is downwind from the user. By generating bubbles, the user can readily visually determine which direction the wind is blowing. When near a mountainside, cove or other mountainous feature that disturbs the wind, it is helpful to be able to visually see where the wind is blowing, as it may have an alternative path from the main direction of the wind blowing across the given area. In some instances, this airflow path can create swirling, curve, eddy, countercurrent or other types of airflow patterns that are readily ascertained when disseminating an animal scent solution in the form of bubbles. It is also much easier to leave a trail of animal scent solution as a user is hiking through a given area.

When hunting, it is extremely important to understand the surrounding wind and air movement patterns. Wind causes air movement, but there is also a meaningful amount of air movement due to thermals (temperature gradients causing pressure gradients), as well as air movement deflecting up, down, and around various environmental features such as trees, hills, rocks, and so on. As such, it is exceedingly difficult for one to understand air movement in a given area without some sort of wind indicator. In the prior art, users may throw dust, seeds, or smoke, but these have limitations of giving off odd smells, quickly falling out of the air, and being unreliable. The present scented bubbles not only provide a luring and/or covering scent in an area, but also are able to provide precise information about air movements due to their extremely light weight and ability to float for long periods of time. Even with effective covering scent, it is very important for a hunter to place him or herself in a good location so that the deer is less likely to smell the hunter. Once positioned, the hunter can spray, blow, or otherwise generate bubbles and as they float along the air currents, they will disseminate the smell. The smell will inherently lead an animal directly to the hunter in position.

The ability to see very detailed air flow patterns allows the hunter to identify a good location for positioning. Indeed, deer and other animals are highly sensitive to unusual conditions in their environment and can detect minute changes or oddities. Anything out of the ordinary will put a deer or other animal on alert, and potentially scare them off. Existing prior art bubbles such as children's bubbles are immediately apparent as a warning to a deer or other animal because they smell like soap and the chemicals used in typical store-bought bubble liquid. The bubble forming composition of the present disclosure is, in preferred embodiments, formed of scent free, dye free, and biodegradable components to be as non-alerting to animals as possible.

Referring now to Tables 1-3 which illustrate various formulations of an animal scent solution configured to generate bubbles to travel through the air. Table 1 and 2 refers to specific ingredients used in two types of animal scent formulation, while Table 3 illustrates one embodiment of a list of the types of components that can be utilized to create an embodiment of the animal scent solution configured to form bubbles. Other embodiments may omit certain of these components, such as, but not limited to the pH optimizer.

TABLE 1
First Formulation:

Water
Glycerin
Sodium lauryl sulfate
Decyl glucoside
Magnesium chloride
Citric Acid
Benzisothiazolinone
Methylisothiazolinone
Scent

TABLE 2
Second Formulation:

Water
Glycerin
Sodium lauryl sulfate
Sodium laureth sulfate
Sodium chloride
phenoxyethanol
copolymer
Methylisothiazolinone
Scent

TABLE 3
Exemplary Formulation Components:

Water
Detergent
ph optimizing component
Glycerin, sugars (glucose, sucrose, etc.) and/or polymers
Scent

The first formulation in Table 1 includes: Water, Glycerin, Sodium lauryl sulfate, Decyl glucoside, Magnesium chloride, Citric Acid, Benzisothiazolinone, Methylisothiazolinone, and a scent. In certain embodiments, the composition may have only these components. For deer hunting the scent can include a deer scent, which can be derived from components such as buck or doe urine, other animal urine such as fox urine, acorn scent, or pine scent. The deer urine is often used as a luring scent, to trick the deer into believing another deer is in the area, as well as an effective covering scent to mask the smell of the human. The acorn scent is a sweeter scent that can also be used as a luring scent, whereas the pine scent can be used as a cover scent to mask or cover the user's human scent.

In another embodiment, the bubble-forming composition may have: Water, Glycerin, Sodium lauryl sulfate, Sodium laureth sulfate, Sodium chloride, phenoxyethanol, copolymer, Methylisothiazolinone, and a scent. In certain embodiments, the composition may have only these components.

When comparing the first and second formulations it will be understood that the preferred and desired components of an animal scent may include: water, a detergent, a pH optimizing component, and one of: glycerin, sugars (glucose, fructose, sucrose, or lactose), and a polymer, as well as the scent. The water and detergent ratio is based on the surfactancy of the detergent. One of the objectives is to create bubbles with thicker shells than in traditional bubble solutions, so that they travel further before exploding or popping. It is difficult to create bubbles from water alone, but the higher the water content, the thicker the bubbles are going to be. However, this may depend on the surfactancy of the detergent itself. The pH optimizing component may help to create larger and more uniform bubbles, as they can help the bubbles to close easier and make more efficient use of the detergent, as less detergent generally means thicker bubbles. Glycerin, polymers, and sugars can also contribute to creating stronger bubbles. This is especially the case with vegetable derived glycerin, which provides an especially thick and durable bubble. Glycerin in combination with a polymer can be effective. Sugars can have some impact on the strength as they help to thicken the bubbles as well, but the sugars used can also have an alternative use. The sugars tend to have a sweet smell to them and if used in sufficient quantities can leave a sweet tasting residue where they land.

Sweet smelling and tasting solutions can be particularly helpful when bear hunting, as Bears tend to like jelly donut, glazed donut and sugar cookie smells among other enticing food scents. These smells coupled with the sweet tasting solution can provide an effective animal scent solution that lures the bear towards the user.

Thus, the combination of the animal scent solutions provided above coupled with techniques of using bubble generating devices (automatic blowing and user-blown types) are an improvement over the traditional spray bottle techniques as the above noted advantages include: better coverage, visual understanding of wind direction, further spreading, more natural coverage based on the wind blowing, the bubbles follow the path of where the user's scent is being blown, and an optimized use of certain scents like deer or animal urine. Buck urine in particular can be fairly expensive, so to be able to disseminate it in a more cost effective manner is also an advantage.

Of course, the present invention is not limited to the above features and advantages. Those of ordinary skill in the art will recognize additional features and advantages upon reading the following detailed description, and upon viewing the accompanying drawings.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

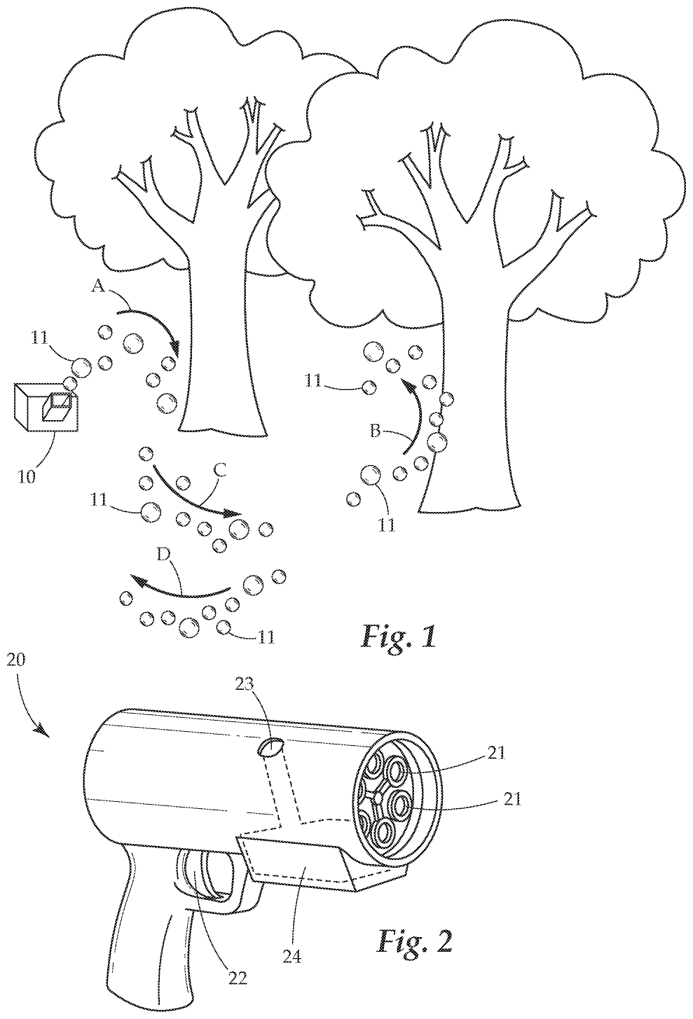

Turning to the figures, FIG. 1 provides a view of an embodiment of the scented bubble composition being formed into bubbles by a bubble generating machine to disseminate scent and to identify wind and air current directions. The bubble generating device is shown here as a bubble machine 10 though any bubble generating device may be used. The bubble machine 10 blows a plurality of bubbles 11 which gently float and blow as guided by the wind and air currents. For example, a tree causes an air current A which draws the bubbles downward along the tree trunk. A swirling air current B lifts bubbles 11 upward following a tree trunk and then away from the trunk and swirling. A small hill draws air and bubbles along its crest and downwardly along air current C, and at the same time, pushes bubbles 11 upward on the other side of the hill via air current D. Upon popping, the bubbles deposit the scented component onto nearby surfaces and emit the desired scent. In many cases, the scent trail left by the bubbles will draw an animal to the bubble source due to the fact that the wind and air is carrying the bubbles from their starting point in the wind direction. Necessarily, by nature of the bubbles, some bubbles will pop close to the source of the bubble machine, and others will trave a long way via wind/air currents.

FIG. 2 provides a view of an embodiment of a bubble generating device, in this embodiment, a bubble gun. The bubble gun 20 has a reservoir 24 into which the scented bubble forming composition is stored. This can be re-filled via opening 23 into which the scented bubble forming composition can be poured. The bubble gun has a blower (not shown) which blows air over a plurality of apertures 21. The apertures 21 are movable between being in contact with the reservoir 24 to collect bubble forming composition and form a film across the aperture, and to the blower which blows across the aperture 21 to create the bubble and to propel the bubble. A trigger 22 can be pulled by a user which activates a motor or motor to cause the blower (such as a fan) to blow and causes the apertures 21 to move as discussed above. In combination these operate to blow a plurality of bubbles as directed by the user. The bubbles used are formed from the bubble forming composition such as that disclosed herein which contains a scent component operable to mask the scent of a person or people nearby and also to lure the animal towards the source of the bubbles.

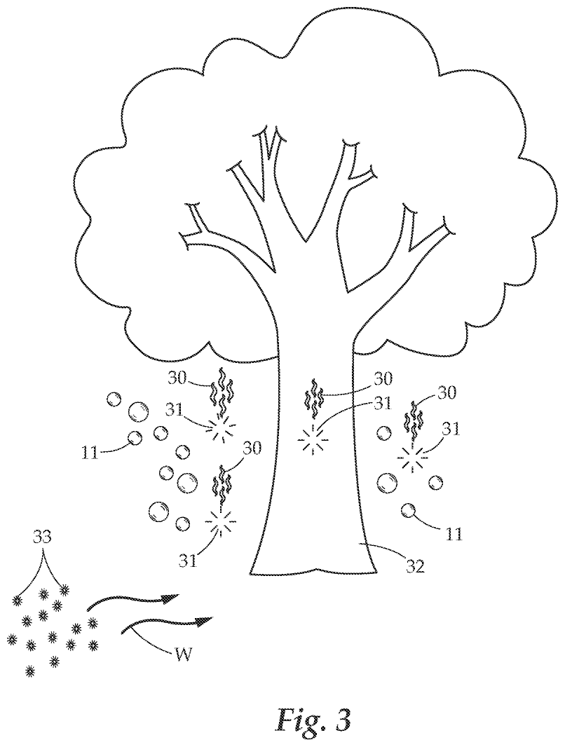

FIG. 3 provides a view of bubbles applying the scent component to the surfaces on which they land. Bubbles 11 of the bubble forming composition disclosed here are blown throughout a local environment. These bubbles 11 land on surfaces such as tree 32 and emit scent 30 and leaving bubble residue 31 which can emit further scent 30 as it evaporates. The bubbles 11 are carried by the wind W. Importantly, human scent particles 33 are also carried by this wind but these particles are masked by scent 30. Because the wind W carries human scent particles 33 in the same direction as the bubbles 11, and because the two carry approximately the same distances, the bubbles 11 are optimally positioned to emit scent 30 to cover for the human scent particles 33.

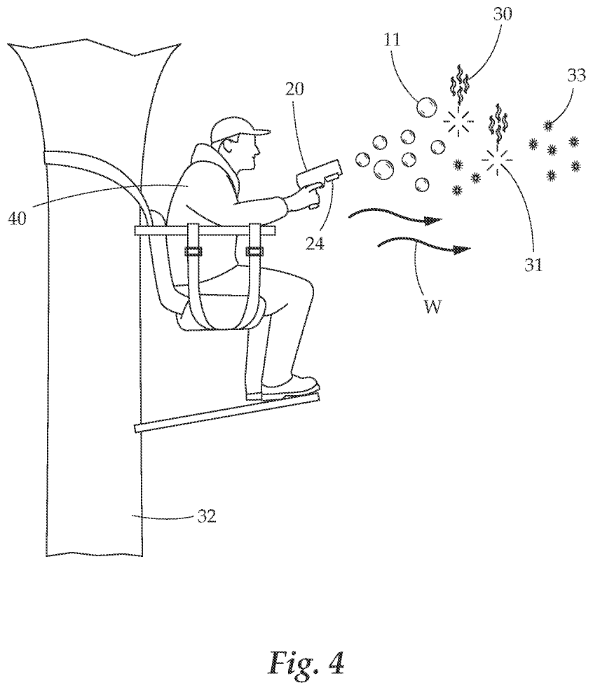

FIG. 4 provides a view of an embodiment of disseminated bubbles applying the scent component to the surfaces on which they land. Here, a hunter 40 is in a tree stand and uses a bubble gun 20 to spray bubbles 11. These bubbles 11 are carried by the wind W and air currents in the same direction as any emitted human scent 33. Because the bubbles are formed of the bubble forming compositions disclosed herein, they contain a scent component which can mask and/or lure the desired animal towards the bubble source and also mask human scent which necessarily travels in the same direction as the bubbles.

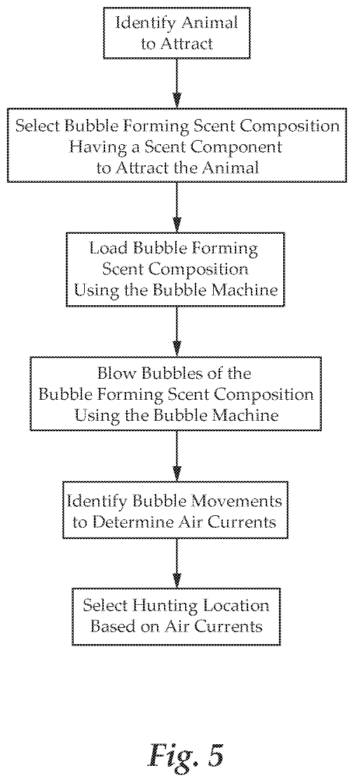

FIG. 5 provides a flow chart of operation of an embodiment of the system disclosed herein. The process begins with identifying an animal to attract, and then selecting a bubble forming scent composition having a scent component to attract the animal. This selected scent may also be useful in masking the scent of a hunter or other humans. The bubble forming scent composition is then loaded into a bubble machine such as a bubble gun. The bubble gun then can be used to blow the scented bubbles which will identify the air currents and wind, and allows a hunter to select a hunting location based on the air currents and wind.

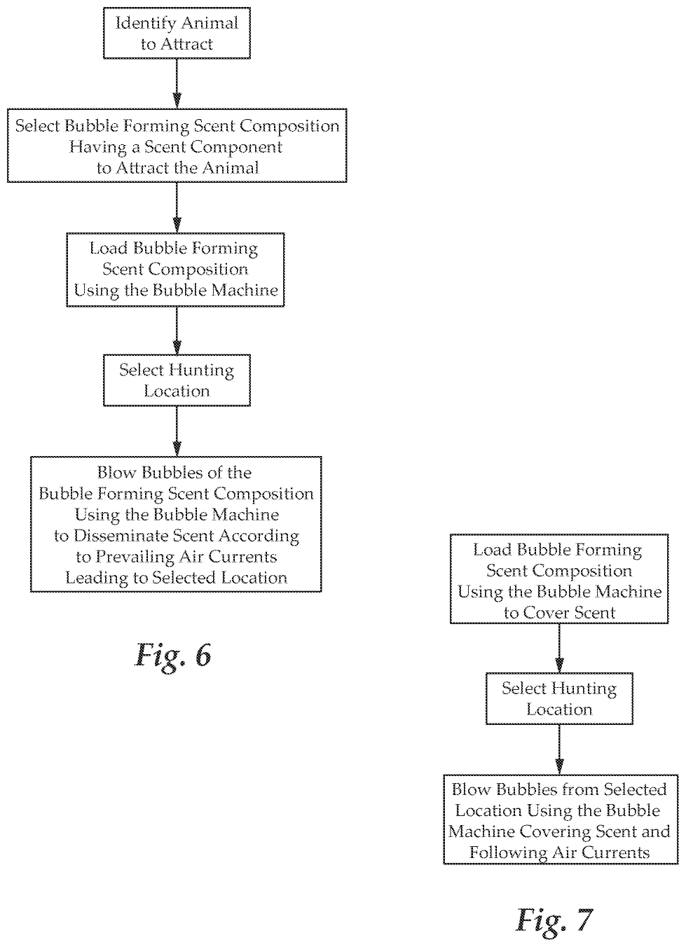

FIG. 6 provides a flow chart of operation of another embodiment of the system disclosed herein. The method involves selecting an animal to attract and the corresponding appropriate bubble forming scent composition. The composition is loaded into a bubble machine. The hunter may select a hunting location and blow bubbles of the bubble forming scent composition using the bubble machine to disseminate scent according to prevailing air currents leading to selected location.

FIG. 7 provides a view of another embodiment of steps involved in the present disclosure. The bubble forming scent composition is loaded into a bubble machine (or other bubble device, including a bubble wand) to provide a cover scent by blowing the scented bubble forming scent composition to disperse and disseminate the scent. Based on bubble movement, which follows air movement, a user can select a hunting location to position him or herself in a proper position to limit smells being picked up by an animal. Once the location is selected, the user can blow additional bubbles from the selected location using the bubble generating device. This will further cover any human scent which is carried to the same area that the bubbles are, by the same air currents and wind that carry the bubbles.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A method for disseminating an animal scent solution comprising the steps of:
placing an animal scent solution into a bubble generating device, wherein the animal scent solution is comprised of:
water,
detergent,
at least one of glycerin, sugar and polymer, and
a scent component for covering scent, or luring an animal;
disseminating the animal scent solution downwind from the user in the form of bubbles as generated by the bubble generating device; and
determining the direction of surrounding air currents based on a direction of travel of the bubbles generated.

2. The method for disseminating an animal scent solution of claim 1, wherein the scent component comprises animal urine.

3. The method for disseminating an animal scent solution of claim 1, wherein the scent component comprises an animal-derived component.

4. The method for disseminating an animal scent solution of claim 1, wherein the scent component is comprised of at least one of: a jelly donut scent, a glaze donut scent, and a sugar cookie scent.

5. The method for disseminating an animal scent solution of claim 1, wherein the bubble generating device is a bubble wand having an aperture and radial channels extending towards the aperture.

6. The method for disseminating an animal scent solution of claim 1, wherein the bubble generating device is an automated bubble machine having a plurality of apertures which can be positioned in front of a fan which is configured to move airflow across the aperture.

7. The method of claim 1 wherein the step of placing the animal scent solution comprises the step of selecting the animal scent solution to be operable to cover a human scent.

8. The method of claim 1 wherein the step of placing the animal scent solution comprises the step of selecting the animal scent solution to be operable to lure an animal.

9. A bubble-forming scent composition comprising:
water;
detergent;
at least one of glycerin, a sugar, and a polymer; and
a scent component.

10. The bubble-forming scent composition of claim 9 wherein the scent component is an animal urine.

11. The bubble-forming scent composition of claim 9 wherein the scent component is an animal-based component selected to provide a scent that is, or mimics, an animal scent.

12. The bubble-forming scent composition of claim 9 wherein the scent component is an plant-based component selected to provide a scent that is, or mimics, a plant scent.

13. The bubble-forming scent composition of claim 9 comprising vegetable glycerin.

14. The bubble-forming scent composition of claim 9 wherein the detergent and the at least one of glycerin, sugar, and polymer is scent-free, dye-free, and biodegradable.

15. A scent dissemination system comprising:
a bubble generator operable to form bubbles from a bubble-forming composition; and
the bubble forming scent composition of claim 9.

16. The scent dissemination system of claim 15 wherein the bubble generator is an automated bubble machine having a blower to blow air, and a plurality of apertures movable between a bubble forming composition reservoir and in front of the blower.

17. The scent dissemination system of claim 15 wherein the bubble generator is an automated bubble gun having a trigger, and a blower to blow air, and a plurality of apertures movable between a bubble forming composition reservoir and in front of the blower, the trigger operable to activate the blower and a motor to move the plurality of apertures.

18. The scent dissemination system of claim 15 wherein the bubble generator is a stick with a loop.

19. The scent dissemination system of claim 15 wherein the scent component is an animal urine.

20. The scent dissemination system of claim 15 wherein the scent component is an animal-based component selected to provide a scent that is, or mimics, an animal scent.
